(19) United States
(12) Patent Application Publication
(10) Pub. No.: US 2006/0064500 A1
(43) Pub. Date: Mar. 23, 2006

(54) Caching control for streaming media

(75) Inventors: David J. Roth, Seattle, WA (US); Eduardo P. Oliveira, Redmond, WA (US); Anders E. Klemets, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/264,527

(22) Filed: Nov. 1, 2005

Related U.S. Application Data
(62) Division of application No. 10/180,262, filed on Jun. 26, 2002.

(51) Int. Cl. G06F 15/16

(52) U.S. Cl. 709/231

(57) ABSTRACT

Improved caching control for streaming media includes one or more cache control directives associated with streaming media content that can be used by a source of the streaming media content to identify how caching proxy servers are to handle the streaming media content. Upon receipt of the streaming media content, the caching proxy servers handle the content as indicated by the cache control directive(s).

### RELATED APPLICATIONS

This application is a divisional application of U.S. patent application Ser. No. 10/180,262, filed Jun. 26, 2002, which is hereby incorporated by reference herein.

### TECHNICAL FIELD

This invention relates to streaming media, and particularly to improved caching control for streaming media.

### BACKGROUND

Content streaming, such as the streaming of audio, video, and/or text is becoming increasingly popular. The term “streaming” is used to indicate that the data representing the media is provided over a network to a client computer on an as-needed basis rather than being pre-delivered in its entirety before playback. Thus, the client computer renders streaming data as it is received from a network server, rather than waiting for an entire “file” to be delivered.

The widespread availability of streaming multimedia enables a variety of informational content that was not previously available over the Internet or other computer networks. Live content is one significant example of such content. Using streaming multimedia, audio, video, or audio/visual coverage of noteworthy events can be broadcast over the Internet as the events unfold. Similarly, television and radio stations can transmit their live content over the Internet.

Many client computers requesting content from server computers over a network, such as the Internet, access the server computers via a proxy server. Proxy servers provide, for example, a centralized location for multiple client computers to access the Internet, easing security management for the system administrator. Proxy servers may also cache content and serve the content to requesting client computers, thereby alleviating the server computer from the burden of providing the same content to multiple client computers behind the same proxy server.

However, one problem encountered in streaming media is that these proxy servers are typically designed for non-streaming content. Such non-streaming content generally does not have the same types of interactions between the client and server computers during delivery as is commonly found in streaming content, nor do they account for the differences in the nature of the content (e.g., differences between a media file of known size and a live broadcast of unknown size). Current proxy servers therefore do not perform well in handling streaming media content. Thus, it would be beneficial to improve the manner in which streaming media content can be handled by proxy servers.

The improved caching control for streaming media described below solves these and other problems.

### SUMMARY

Improved caching control for streaming media is described herein.

According to one aspect, one or more cache control directives associated with streaming media content are used by a source of the streaming media content to identify how caching proxy servers are to handle the streaming media content. Upon receipt of the streaming media content, the caching proxy servers handle the content as indicated by the cache control directive(s).

In one implementation, a proxy split directive is used to indicate that streaming media content that is a broadcast stream can be split by the caching proxy server.

In one implementation, a proxy cache directive is used to indicate that the media stream can be cached by the caching proxy server only if the caching proxy server is a streaming media caching proxy server.

In one implementation, an authentication directive is used to indicate that authentication of a client requesting the media stream is required as well as one or more authentication packages that can be used for the authentication.

In one implementation, a content size directive is used to identify a size of the streaming media content.

In one implementation, an event subscription directive is used to indicate which of one or more events regarding the streaming media content are to be communicated to an origin server associated with the streaming media content.

In one implementation, an event header is used by the caching proxy server in sending event data to an origin server associated with the streaming media content. The event header is included in a message by the caching proxy server to indicate that the message includes event data.

In one implementation, a stream type directive is used to indicate a type of the media stream content.

### BRIEF DESCRIPTION OF THE DRAWINGS

The same numbers are used throughout the document to reference like components and/or features.

FIG. 1 illustrates an exemplary network environment.

FIG. 2 illustrates exemplary client and server devices.

FIG. 3 illustrates an exemplary message format that may be used in communicating streaming media data.

FIGS. 4a, 4b, and 4c are a flowchart illustrating an exemplary process for streaming media content using a streaming media caching proxy server.

FIG. 5 illustrates an exemplary general computer environment.

### DETAILED DESCRIPTION

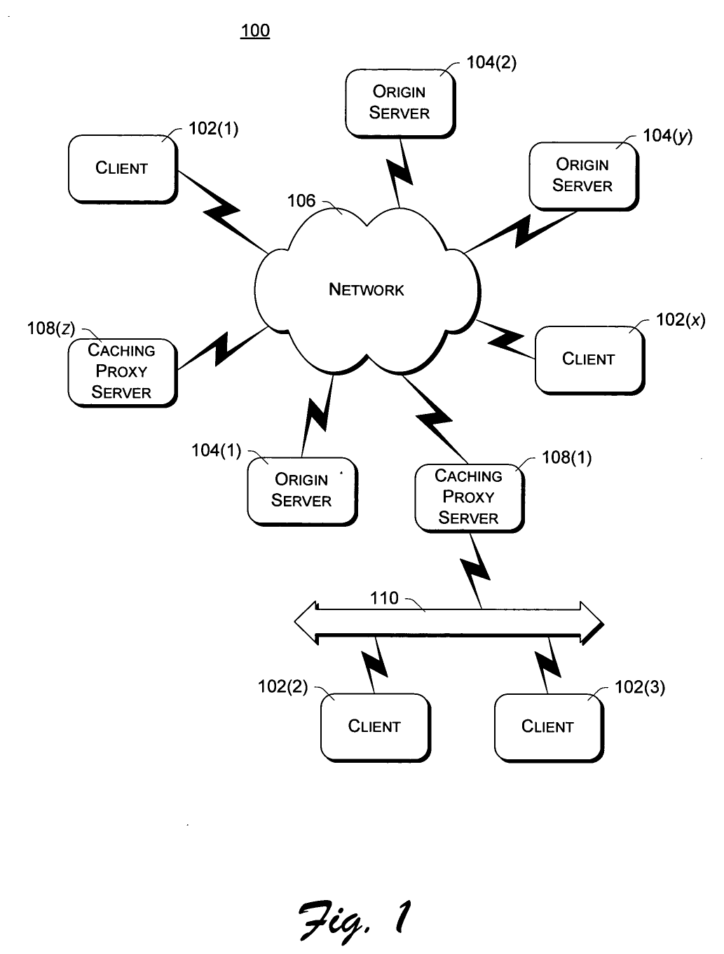

FIG. 1 illustrates an exemplary network environment 100. In environment 100, multiple (x) client computing devices 102(1), 102(2), 102(3), . . . , 102(x) are coupled to multiple (y) origin server computing devices 104(1), 104(2), . . . , 104(y) via a network 106. Network 106 is intended to represent any of a wide variety of conventional network topologies and types (including wired and/or wireless networks), employing any of a wide variety of conventional network protocols (including public and/or proprietary protocols). Network 106 may include, for example, the Internet as well as possibly at least portions of one or more local area networks (LANs).

One or more streaming media caching proxy server devices 108(1), . . . , 108(z) may also be included and act as intermediaries between one or more client devices 102 and one or more origin server devices 104. A request to access streaming media content available from an origin server device 104 is routed from the client device 102 to one of the proxy servers 108, which may obtain the content from the origin server device 104 on behalf of the client, or may supply the content to the client device 102 from its own cache or based on content it is already receiving as discussed in more detail below. For example, client device 102(2) may access network 106 via a LAN 110 and caching proxy server 108(1). Under certain circumstances, discussed in more detail below, when client 102(2) requests content from origin server 104(2) caching proxy server 108(1) may supply the content to client 102(2) with little or no communication to origin server 104(2).

Computing devices 102, 104, and 108 can each be any of a wide variety of conventional computing devices, including desktop PCs, workstations, mainframe computers, Internet appliances, gaming consoles, handheld PCs, cellular telephones, personal digital assistants (PDAs), etc. One or more of devices 102, 104, and 108 can be the same types of devices, or alternatively different types of devices.

Server devices 104 can make any of a wide variety of data available for streaming to clients 102. The term “streaming” is used to indicate that the data representing the media is provided over a network to a client device on an as-needed basis rather than being pre-delivered in its entirety before playback. The data may be publicly available or alternatively restricted (e.g., restricted to only certain users, available only if the appropriate fee is paid, etc.). The data may be any of a variety of one or more types of content, such as audio, video, text, animation, etc. Additionally, the data may be “on-demand” (e.g., pre-recorded and of a known size) or alternatively “broadcast” (e.g., having no known size, such as a digital representation of a concert being captured as the concert is performed and made available for streaming shortly after capture).

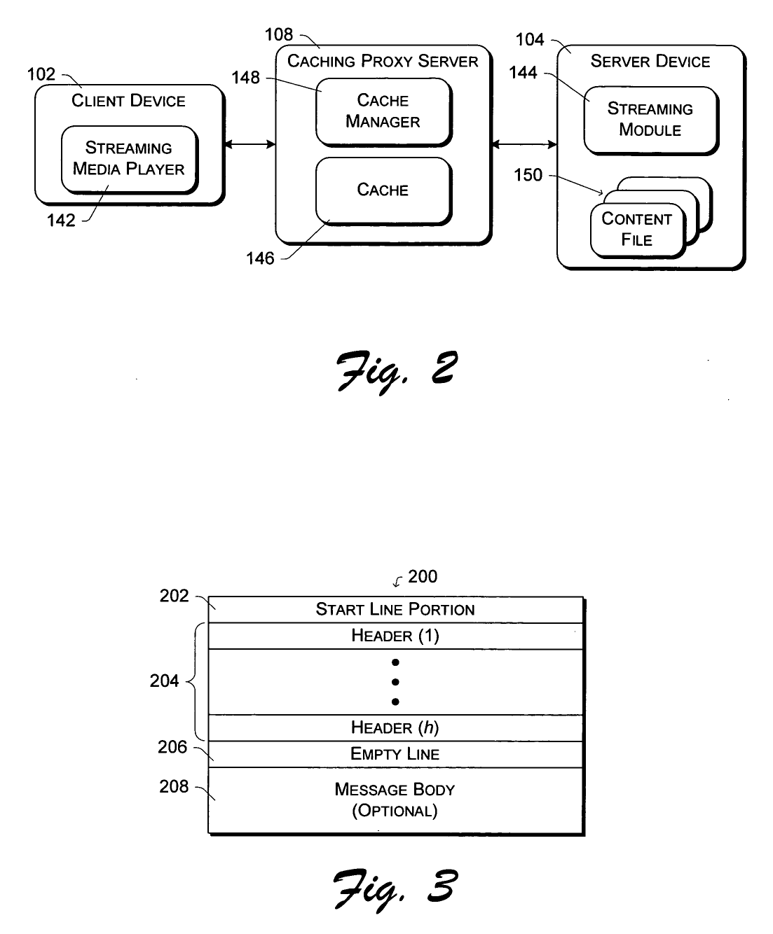

FIG. 2 illustrates exemplary client and server devices. Client device 102 includes a streaming media player 142 configured to access a streaming module 144 of origin server device 104 via streaming media caching proxy server 108. Streaming media caching proxy server 108 includes a cache 146 and cache manager 148. Origin server device 104 also includes one or more streaming media content files 150 from which a selection can be made by media player 142 (e.g., based on user input at player 142) and the selected content file streamed to player 142. Device 104 is the source (optionally one of multiple sources) for media content files 150, and thus is referred to as the origin server. Although not shown in FIG. 2, one or more additional devices (e.g., firewalls, routers, gateways, bridges, additional proxy servers, etc.) may be situated between client device 102 and server device 104. It should be noted that multiple clients 102 may access server 104 via proxy server 108, and that multiple servers 104 may be accessed by a client(s) 102 via proxy server 108, although only a single client 102 and server 104 have been shown in FIG. 2 for ease of explanation.

Streaming media flows from server device 104 to streaming media caching proxy server 108 and on to client device 102 (in some situations, discussed in more detail below, the flow may begin from proxy server 108 using data in cache 146). The flow of data can thus be thought of as “downstream” towards client device 102, and “upstream” towards server device 104. One or more additional streaming media caching proxy servers may be included upstream from server 108 (that is, between server 108 and server 104), and one or more additional streaming media caching proxy servers may be included downstream from server 108 (that is, between server 108 and client 102).

Communication among devices 102, 104, and 108 can occur using a variety of different protocols. In one implementation, communication among devices 102, 104, and 108 occurs using a version of the HyperText Transport Protocol (HTTP), such as version 1.1 (HTTP 1.1). In another implementation, communication among devices 102, 104, and 108 occurs using the Real Time Streaming Protocol (RTSP). Alternatively, other protocols may be used.

Cache manager 148 of streaming media caching proxy server 108 manages the caching of streaming media content from origin server 104. Different pieces of streaming media content are illustrated as different files 150 in FIG. 2, although alternatively a piece of streaming media content may be stored as multiple files (or, in the case of broadcast content, as no file). The manner in which a “piece” of content is defined can vary by implementation and based on the type of media. For example, for musical audio and/or video content each song can be a piece of content. Content may be separated into pieces along natural boundaries (e.g., different songs), or alternatively in other arbitrary manners (e.g., every five minutes of content is a piece).

Each piece of media content may include multiple streams, even though they may be stored together as a single file. Each such stream represents a particular type of media (e.g., audio, video, text, etc.), typically at a particular bit rate. Multiple versions of the same type of media (e.g., multiple audio versions, multiple video versions, etc.) may be included in the media content, allowing selection of different combinations of these streams (e.g., based on user preference, network bandwidth, etc.) for playback by media player 142. When caching content, cache manager 148 stores in cache 146 the particular streams (as requested by streaming media player 142) received from origin server device 104 as the streaming media content. Different stream combinations for the same piece of media content can be cached by cache manager 148. Alternatively, cache manager 148 may obtain all the streams for particular media content from origin server device 104 and cache all of the streams, but stream only the requested streams to media player 142.

Multiple pieces of content may also be grouped together in a play list, which is a list of one or more items each of which is a particular piece of content to be streamed. These different pieces of content can be selected (e.g., by the user or by some other party) to be grouped together in a play list, allowing a user to select all of them for rendering simply by selecting the play list. By way of example, a user may select twenty of his or her favorite songs to be part of a play list, and subsequently have those songs played back to him or her by selecting playback of the play list.

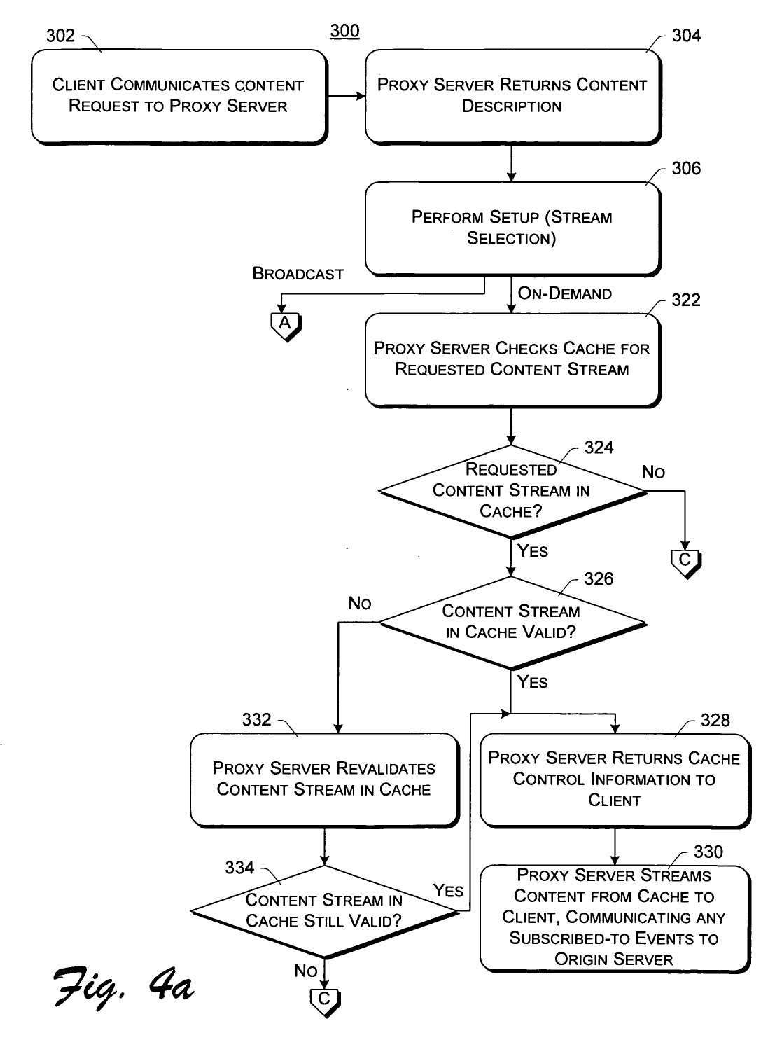

FIG. 3 illustrates an exemplary message format that may be used in communicating streaming media data. The data structure 200 of a message, such as an HTTP 1.1 message or RTSP message, includes a start line field or portion 202, one or more header fields or portions 204, an empty line field or portion 206, and an optional message body field or portion 208. Start line portion 202 contains data identifying the message or data structure type, which can be either a request-line (e.g., for an HTTP 1.1 GET request or an RTSP GET_PARAMETER request) or a status-line (e.g., for an HTTP/1.1 200 OK response or an RTSP/1.0 200 OK response). One or more headers 204 are also included that contain data representing information about the message. An empty line portion 206 is used to identify the end of the headers 204. Additional data may optionally be included in message body portion 208. In the discussions herein, cache control directives are included as headers 204, although these directives may alternatively be situated in message body 208 of FIG. 3.

Control information (e.g., for setting up the streaming of media content) as well as data (e.g., the streaming media content) is communicated among devices 102, 104, and 108 of FIG. 2 as appropriate using messages with data structure 200. These messages thus correspond to or are associated with the media content being streamed. In one implementation, each of the messages destined for a client device, whether the message originates with origin server 104 or proxy server 108, includes a cache control header(s) identifying the cache control information for the associated streaming media content. Alternatively, fewer than all of the messages destined for a client device may include headers with the cache control information (e.g., only the first message or the first few messages of the streaming media data being sent, or alternatively messages may be selected randomly to include the headers, or messages that are at regular or irregular intervals (e.g., every half-second, every five seconds, every ten minutes, etc.,), or messages that are responses to messages from the client device (or proxy server) may include the headers with the cache control information).

Generally, streaming media caching proxy server 108 need not be concerned with whether there are any additional streaming media caching proxy servers situated between server 108 and client 102, or between server 108 and origin server 104. Messages that include cache control information are passed by proxy server 108 to the next downstream component, which server 108 may view as the client 102 even if it is not the client 102. Thus, the cache control information is passed through to all of the proxy servers (whether streaming media caching proxy servers or not) that use the information.

Alternatively, situations may arise where streaming media caching proxy server 108 knows that no additional proxy servers (whether streaming media caching proxy servers or not) are situated between proxy server 108 and client 102. In such situations, proxy server 108 need not (but may) pass the cache control information through to the client 102.

Additionally, streaming media caching proxy server 108 typically does not alter the cache control information it receives. However, situations may arise where server 108 desires to alter the cache control information it receives, in which case server 108 can optionally do so. For example, server 108 may desire that no other downstream proxy servers (whether streaming media caching proxy servers or not) cache the associated content, and may adjust the cache control information accordingly.

When a streaming media caching proxy server is caching streaming media content, the cache control information that the streaming media caching proxy server receives is stored along with the content. Typically, only a single copy of cache control information need be stored (even though multiple copies may be received from the origin server), although alternatively multiple copies may be stored. When serving data to a client from its cache, the streaming media caching proxy server adds the cache control information to the messages being sent to the client as appropriate. By saving the cache control information, the streaming media caching proxy server can communicate the cache control information to any downstream proxy servers, and further can access the cache control information in order to behave appropriately when a request for the cached content is received from a client.

Headers 204 can include one or more cache control headers that are used by origin server 104 of FIG. 2 to communicate cache control information to streaming media caching proxy server 108, and from proxy server 108 to client 102 (or alternatively to any other downstream streaming media caching proxy servers 108 situated between server 108 and client 102). These headers contain information describing how caching of the associated data stream is to be handled by cache manager 148 (as well as the cache manager 148 of any other intermediary streaming media caching proxy servers). Typically headers 204 include a single cache control header, although multiple cache control headers may optionally be included.

In one implementation, a single cache control header can include multiple directives (each of which may have zero or more associated options), each directive (with any associated option(s)) identifying different cache control information. Multiple options may be chained together for a particular directive, or alternatively the directive may be included multiple times each time with a different option. An example format of a cache control header is as follows:
Cache-control: directive[=“option[, option2[, . . . ]]”][,directive2[=“option[, option2[, . . . ]]”][, . . . ]]
   where brackets are used to show optional parameters. Alternatively, a separate header may be used for each directive (with any associated option(s)).

A discussion of the various directives and any associated option(s) follows. Additionally, Table I below includes a summary of the various directives and options. The directives are: a proxy cache directive, an authentication directive, a content size directive, an event subscription directive, a proxy split directive, and a stream type directive. Any combination of directives with associated options may be included in a cache control header. It should be noted that other cache control directives (e.g., well-known conventional HTTP or RTSP cache control directives) may also be included in the cache control header.

A proxy cache directive is included to indicate that the corresponding streaming media content can be cached by a streaming media caching proxy. This directive is typically used in conjunction with another conventional no-cache directive that is understood by non-streaming media caching proxy servers. A proxy server that does not understand the cache control information described herein does not understand the proxy cache directive (and ignores it), so the conventional no-cache directive indicates to that proxy server that it cannot cache the associated content. However, a proxy server that does understand the cache control information described herein does understand the proxy cache directive, which overrides the conventional no-cache directive, and thus such a proxy server can cache the associated content. In one implementation, the following headers are included to indicate that only a streaming media caching proxy server can cache the associated content:
Pragma: no-cache
Cache-control: no-cache, proxy-public
   The Pragma header is a general-header field used to include implementation specific directives. The Cache-control header is used to specify directives that are to be obeyed by all caching mechanisms that receive the message.

Depending on the protocol used, headers to indicate that only a streaming media caching proxy server can cache the associated content may or may not be included. For protocols that are designed for both streaming and non-streaming media (e.g., HTTP), the indication that a streaming media caching proxy server (but not a non-streaming media caching proxy server) can cache the associated content is typically used. However, for protocols that are designed specifically for streaming media (e.g., RTSP), the indication that only a streaming media caching proxy server can cache the associated content is not needed (and thus is typically not used).

An authentication directive is included to indicate that server 104 requires any client accessing the content (whether from server 104 or from cache 146 of proxy server 108) to be authenticated. The directive has one or more associated options that identify the authentication packages supported by server 104. An authentication package refers to the manner in which the client's credentials (e.g., user ID and password, certificate of client 102 or streaming media player 142, etc.) are to be submitted (e.g., whether the credentials are to be encrypted, if the credentials are to be encrypted how they are to be encrypted, etc.). The authentication directive thus informs proxy server 108 that client 102 is to be authenticated and how that authentication is to occur.

In one implementation, the following header is used to indicate that authentication of the client is required:
Cache-control: x-wms-authentication=“options(s)”
   where option(s) represents the authentication package(s) supported by the origin server.

Any of a wide variety of public and/or proprietary authentication packages may be supported by the origin server and thus indicated in the authentication directive. Examples of such authentication packages include: Basic (requires user ID and password but does not use encryption), the well-known NT challenge/response scheme (Ntlm), Digest (includes a challenge using a nonce value and requires a response including a checksum of the user name, the password, the given nonce value, the request verb (e.g., GET, POST, etc.), and identifier of the requested content), Negotiate (uses the well-known Kerberos authentication scheme), Passport (relies on the Microsoft® Passport service for authentication), and so forth.

A content size directive is used to identify the size of the associated streaming media content. By including the size of the associated streaming media content, the streaming media caching proxy server can make an informed decision as to whether to cache the content based on available space in the proxy server's cache. In one implementation, the following header is used to indicate the size of the streaming media content:
Cache-control: x-wms-content-size=“NumBytes”
   where NumBytes represents the number of bytes in the content. Alternatively, measures other than bytes may be used (e.g., bits, double words, quad words, etc.).

An event subscription directive allows the origin server to indicate which events regarding the streaming media content that the origin server (the source of the streaming media content) is to be notified about. Many origin servers desire to s have information about the rendering of the streaming media content at a client (e.g., so they can keep track of what content has been rendered at clients). Since the client's request for content may be satisfied by the proxy server using the content in its cache rather than obtaining the content from the origin server, situations can arise where the proxy server is not in communication with the origin server when streaming the content to the client. The event subscription directive allows the origin server to inform the proxy server what events the proxy server should notify the origin server of when streaming media content from its cache.

In one implementation, the origin server can subscribe to one or more of three events: an open event (e.g., using the remote-open option with the directive), a close event (e.g., using the remote-close option with the directive), and a log event (e.g., using the remote-log option with the directive). The open event refers to a client beginning streaming of the streaming media content from the streaming media caching proxy server. The close event refers to the client ending streaming of the streaming media content from the streaming media caching proxy server. The log event refers to the client sending a log for the streaming media content to the streaming media caching proxy server. Such a log may include, for example, the amount of time spent rendering the content, which portions of the content were rendered multiple times, which portions of the content were skipped over, whether rendering of the content was paused and if so at what point(s) in the content did the pausing occur, problems with the network connection via which the streaming content is received, and so forth).

In alternate embodiments, any of a wide variety of additional events may also be subscribed to. Virtually any request communicated from the client to the streaming media caching proxy server, or any action taken on the part of the streaming media caching proxy server in serving data from its cache to the client, can be subscribed to by the origin server.

When a subscribed-to event occurs, the streaming media caching proxy server sends an indication of the event to the origin server. The streaming media caching proxy server may send this indication when the event occurs (or shortly thereafter), or alternatively group one or more indications together and send them as a group (e.g., at regular or irregular intervals, such as every hour or at 3:00 AM every day; when at least a threshold number of events have occurred; etc.).

In one implementation, the following header is used to subscribe to particular events:
Cache-control: x-wms-event-subscription=“event(s)”
   where event(s) represents the events being subscribed to (e.g., one or more of remote-open, remote-close, and remote-log).

The indication of the event that is sent by the streaming media caching proxy server is sent in a message with an event header indicating that the message includes data describing one or more events. The event data is typically included in the message body, but may alternatively be included (partially or completely) in one or more headers of the message. In one implementation, the following header is used to indicate a message includes log information:
Content-Type: application/x-wms-sendevent
   where the content-Type: application/x-wms-sendevent parameter is a Multipurpose Internet Mail Extensions (MIME) that informs the recipient of the request (server 104) how to handle and respond to the request. Additional headers may also be included in the message, such as a Content-Length:size header indicating the size (as size) of the event data included in the body of the message.

The message including the event data can be any of a variety of types of messages. For example, when using the HTTP 1.1 protocol for streaming media content, a “POST filename HTTP/1.1” message may include the event data, where filename represents the streaming media content file that the event data corresponds to (or alternatively, the name of the log file where the event data is to be stored). By way of another example, when using the RTSP 1.0 protocol for streaming media content, a “SET_PARAMETER rtsp://servername/filename RTSP/1.0” message may include the event data, where rtsp://servername/filename represents the streaming media content file that the event data corresponds to (or alternatively, the name of the log file where the event data is to be stored).

Remote events are typically submitted by the streaming media caching proxy server. However, remote events may also be submitted by other devices, such as the client device. When such events are submitted by another device and received by the streaming media caching proxy server, the streaming media caching proxy server passes them through to their destination (e.g., the origin server). Alternatively, the streaming media caching proxy server may group the remote events with other remote events (from that same device, from other device(s), from the streaming media caching proxy server, etc.) and send them together as a group to their destination (e.g., the origin server).

A proxy split directive is used to indicate that broadcast streaming media content can be split (this directive has no effect on on-demand streaming media content). Broadcast streaming media content is not cached to satisfy subsequent client requests at a streaming media caching proxy server. This refers to long-term caching of the streaming media content—it is to be appreciated that various short term caches or buffers may be employed in the streaming media caching proxy server to temporarily store data of the streaming media content until it can be forwarded to the requesting client(s).

Broadcast streaming media content can, however, be split. Splitting of streaming media content refers to the same content being communicated to multiple clients. Thus, each client receives the same streaming media content. For example, a live speech may be available as broadcast streaming media content. If multiple clients request, via the streaming media caching proxy server, to receive the speech, the streaming media caching proxy server will make a single connection to an origin server for the speech (rather than a separate connection for each of the individual requesting clients). Duplicate messages (or packets, or whatever container is used to communicate the data to the clients) will then be generated by the streaming media caching proxy server for the received data and communicated to the clients so that each client receives the same data for the speech. Thus, for broadcast streaming media content, the content can be split by the streaming media caching proxy server and routed to multiple clients while having only one connection to the origin server (regardless of the number of clients).

In one implementation, the following header is used to indicate that broadcast streaming media content can be split:
Cache-control: x-wms-proxy-split
   When used with HTTP, the x-wms-proxy-split directive overrides any no-cache directive. When used with HTTP or RTSP, the x-wms-proxy-split indicates that the broadcast streaming media content can be split; if this header is not included then the broadcast streaming media content cannot be split.

A stream type directive is used to indicate the type of content that is being streamed. In one implementation, the content type may be on-demand or broadcast, and or play list or non-play list. In the absence of a stream type directive that indicates the content type is broadcast, then it is assumed that the content type is on-demand. And, in the absence of a stream type directive that indicates the content type is play list, then it is assumed that the content type is not a play list. Indicating the type of the content allows the streaming media caching proxy server to make various decisions regarding how to handle the streaming media content. For example, if the content type is broadcast then the streaming media caching proxy server knows it cannot cache the data, but may be able to split the data. By way of another example, if the content type is play list then the streaming media caching proxy server knows that it will be receiving multiple pieces of content as part of the play list and can cache each of these pieces as separate files.

In one implementation, the following header is used to indicate the type of the streaming media content:
Cache-control: x-wms-stream-type=“type(s)”
   where type(s) represents the type of the content (e.g., a type value of “broadcast” to indicate the broadcast type, and/or a type value of “playlist” to indicate the play list type).

These various cache control directives are summarized in Table I.

TABLE 1

| Cache Control | | |
|---|---|---|
| Directive | Options | Description |
| Proxy-public | None | Used to indicate that only a |
| | | streaming media caching proxy |
| | | is allowed to cache the |
| | | associated content. This |
| | | overrides other no-cache |
| | | directives. |
| x-wms-authentication | Basic | Used to indicate that the |
| | Ntlm | origin server requires |
| | Digest | authentication. The list of |
| | Negotiate | options indicate the various |
| | | authentication packages |
| | | supported by the origin server. |
| x-wms-content-size | Size of | Used to indicate the size of |
| | content | the content, which is |
| | (e.g., | included as the option. |
| | in bytes) | |
| x-wms-event- | Remote-open | Used to indicate which remote |
| subscription | Remote-close | event(s) are to be submitted |
| | Remote-log | by the proxy server to the |
| | | origin server. |
| x-wms-proxy-split | None | Used to indicate that |
| | | broadcast streaming media |
| | | can be split. |
| x-wms-stream-type | Broadcast | Used to indicate the type of |
| | Playlist | content that is being |
| | | streamed. |

The cache control information for different pieces of streaming media content can be different. Additionally, the cache control information for a particular piece of streaming media content may be static or alternatively may be dynamic (changing over time). For example, an origin server may initially indicate that authentication is required for a piece of streaming media content, and the content may be cached at a streaming media caching proxy server with this indication. Subsequently, the origin server may decide that authentication is required and change the cache control information accordingly. This change is communicated to the streaming media caching proxy server (e.g., the next time the streaming media caching proxy server revalidates this content in its cache), allowing the streaming media caching proxy server to now behave appropriately (e.g., have the client authenticated before streaming the content to the client from its cache).

An origin server may optionally include an expiration time for streaming media content. This expiration time may be a relative time (e.g., five minutes after the content has been sent) or a fixed time (e.g., a particular date and time). Once expired, the streaming media caching proxy server revalidates the content prior to serving the content to a client. Typically, this revalidation occurs when a request for the content is received from the client, or alternatively it may occur at other times (e.g., as soon as the streaming media caching proxy server detects that the expiration time has passed regardless of whether a client is requesting the content). When content expires, the streaming media caching proxy server retrieves new cache control information for the content, as well as information describing the content (so the server can determine whether the content has changed) and a new expiration time. The streaming media caching proxy server may receive this revalidation information from the origin server, or alternatively an intermediate upstream streaming media caching proxy server.

If the content has not changed, then the streaming media caching proxy server can simply update its expiration date to the new expiration date—no changes to the cached content need be made. If the cache control information has changed (e.g., new directives added or previous directives modified or deleted), then this new cache control information is saved by the streaming media caching proxy server (and used in handling subsequent client requests for the content).

Situations can arise where streaming media content expires while it is being streamed to a client. In one implementation, the streaming media caching proxy server revalidates the content while streaming the content to the client. If the content changes, then the streaming media caching proxy server stops streaming the content from its cache and instead obtains the content from the origin server (and proceeds with streaming the content to the client, except that the content is being received from the origin server rather than from its cache). The streaming media caching proxy server attempts to make a clean switch between the two streams (e.g., waiting for an appropriate breakpoint (e.g., change in songs) if possible), however such clean switches may not be possible. If the cache control information changes during the streaming, then the streaming media caching proxy server makes any changes necessary due to the change in the cache control information. For example, assume that splitting of broadcast content was originally allowed for the content and that the streaming media caching proxy server is splitting the content and sending it to two clients. If the cache control information then changes to indicate that splitting is no longer allowed, then the streaming media caching proxy server stops the splitting and establishes a separate connection for each of the clients to the origin server (one of the clients may be able to continue to use the previous connection to the origin server, or alternatively a new connection may be established for each client).

Alternatively, the streaming media caching proxy server may ignore such expirations for currently streaming content and only revalidate (or use new cache control information) for requests received after the expiration time.

Changes to the cache control information can be detected by the streaming media caching proxy server by comparing the newly received cache control information to the previously received cache control information and checking for any differences. Changes to the content can be detected by checking one or more of various parameters for the content. In one implementation, when revalidating content the origin server returns an indication of the last modified date (e.g., this may be a header 204 of FIG. 3). If the newly received last modified date is different than the previously received last modified date, then the streaming media caching proxy server determines that the content has been changed. Another parameter that may be checked is the size of the content. If the content size has changed, then the streaming media caching proxy server determines that the content has been changed. Another parameter that may be checked is an Entity Tag (ETag) associated with the content. ETags are well-known HTTP tags that can be used to identify changes in content—if the ETag for content has changed then the streaming media caching proxy server determines that the content has been changed. Another parameter that may be checked is a hash of the content. A hash value of the content may be generated using any of a wide variety of conventional hashing algorithms—changes to the content generally result in a change in the hash value of the content. If the hash value has changed, then the streaming media caching proxy server determines that the content has been changed.

In the illustrated example, the streaming media caching proxy server typically does not attempt to determine what change has been made to the content, but rather retrieves the newly changed content and replaces it (e.g., even if only one second's worth of five minutes of content has been changed). Alternatively, the streaming media caching proxy server may attempt to determine what has been changed with the content and replace only the portion(s) which have been changed.

The expiration time for streaming media content can be indicated in a variety of different manners. In one implementation, the expiration time is indicated using the HTTP max-age directive. In another implementation, the expiration time is indicated using the HTTP or RTSP Expires header.

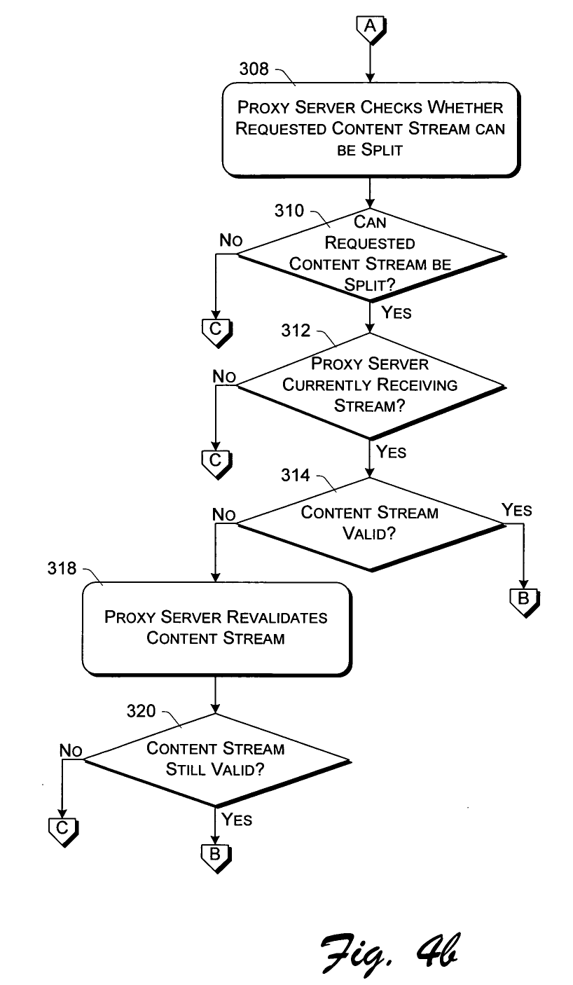

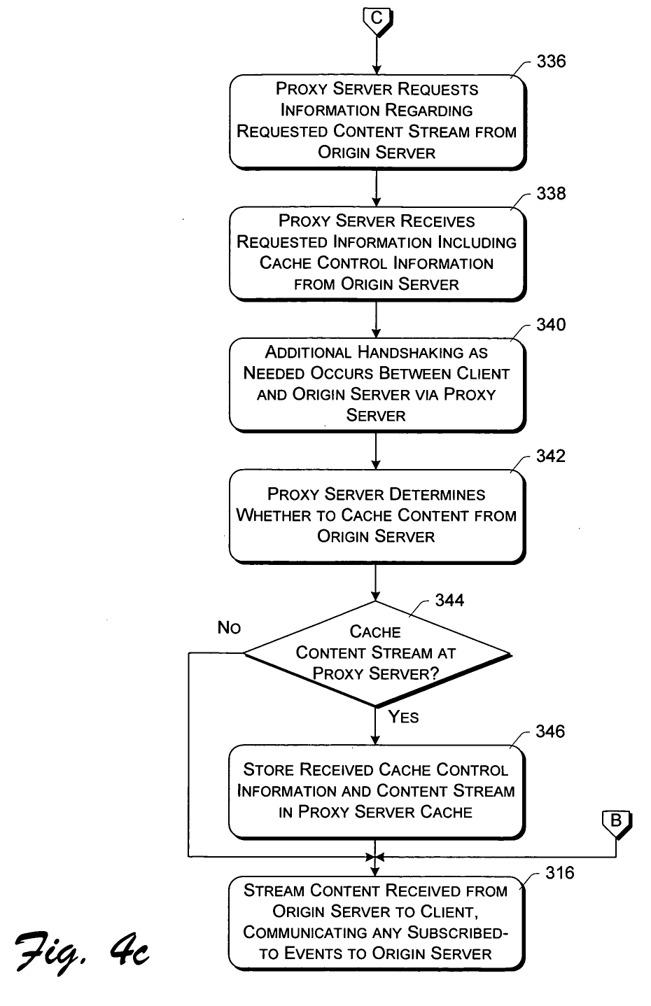

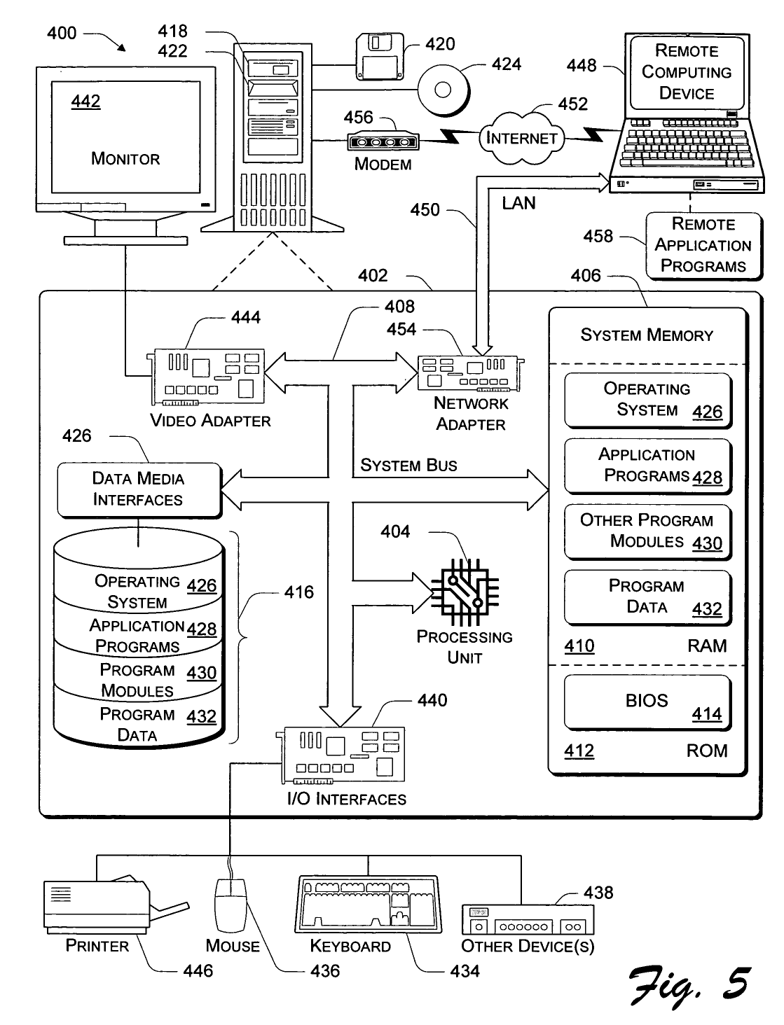

FIGS. 4a, 4b, and 4c are a flowchart illustrating an exemplary process 300 for streaming media content using a streaming media caching proxy server. Process 300 is implemented by a combination of the client device, the streaming media caching proxy server, and the server device, and may be performed in software. FIGS. 4a, 4b, and 4c are discussed with reference to components of FIGS. 2 and 3.

Initially, the streaming media player 142 of client device 102 communicates a request for content to streaming media caching proxy server 108 (act 302). This content request is a describe command that causes server 108 to return (based on its cached information or on information received from the origin server or an upstream streaming media caching proxy server) to client 102 information describing the content. This response includes, for example, one or more of an indication of what type(s) of codec(s) are to be used in decoding the content, what the size of the content is, whether the content is on-demand or broadcast, a bit rate of the content, a description of the content (e.g., title, author, etc.), other meta data associated with the content, and so forth. This describe command may be, for example an RTSP DESCRIBE Request or an HTTP GET Request.

Streaming media caching proxy server 108 returns the requested content description to client 102 (act 304). A setup process then occurs with client 102 requesting a particular one of multiple streams of the content, assuming there are multiple streams for the content (act 306). Particular content may have multiple streams (e.g., all stored as part of the same file), such as high bit rate and low bit rate audio streams, high bit rate and low bit rate audio streams, and so forth.

Streaming media caching proxy server 108 then performs one of two checks based on the whether the requested content stream is on-demand or broadcast (as indicated based on the stream type directive of the cache control information). If the requested content stream is a broadcast stream, then server 108 checks whether the requested content stream can be split (act 308 of FIG. 4b), such as by checking whether the proxy split directive is included in the cache control information. Proxy server 108 then proceeds based on whether the requested content stream can be split (act 310). If the stream cannot be split, then process 300 continues at act 336 described below. However, if the stream can be split, then proxy server 108 checks whether it is currently receiving the requested stream (act 312). If proxy server 108 is not currently receiving the requested stream, then process 300 continues at act 336 described below. However, if proxy server 108 is currently receiving the requested stream, then proxy server 108 checks whether the requested content stream is valid (act 314). In one implementation, if the expiration time of the content stream has not passed, then the content stream is valid. If the content stream is valid, then proxy server 108 proceeds to stream the requested content stream being received from the origin server to the client (act 316 of FIG. 4c), and communicates any subscribed-to events (e.g., as indicated by the event-subscription directive in the cache control information for the content stream) to the origin server.

Returning to act 314 of FIG. 4b, if the content stream is not valid, then proxy server 108 revalidates the content stream (act 318). Proxy server 108 then proceeds based on whether the content stream is still valid (act 320). If the content stream is still valid, then the content stream is split and streamed to the client (act 316 of FIG. 4c). However, if the content stream is not valid, then process 300 continues at act 336 of FIG. 4c.

Returning to FIG. 4a, if the requested content stream is an on-demand stream, then proxy server 108 checks whether the requested content stream is in its cache (act 322). This may be an additional check, or may already have been determined by proxy server 108 in obtaining the content description in act 304. Proxy server 108 then proceeds based on whether the requested content stream is in its cache (act 324). If the requested content stream is not in the cache of proxy server 108, then process 300 continues at act 336. However, if the requested content stream is in the cache, then proxy server 108 checks whether the content stream is valid (act 326). In one implementation, if the expiration time of the content stream has not passed, then the content stream in the cache is valid. If the content in the cache is valid, then proxy server 108 returns the cache control information to the client (act 328) and streams the content stream from its cache to the client, communicating any subscribed-to events (e.g., as indicated by the event-subscription directive in the cache control information for the content stream) to the origin server (act 330). Act 328 may be a separate act as shown, or alternatively may be incorporated into act 330 (e.g., one or more messages including the streaming content data may include the cache control information). Alternatively, the cache control information may have already been returned to client 102 in act 304 or 306 above.

Returning to act 326, if the content stream in the cache is not valid, then proxy server 108 revalidates the content stream (act 332). Proxy server 108 then proceeds based on whether the content stream in the cache is still valid (act 334). If the content stream is still valid, then the cache control information and content stream are streamed to the client (acts 328 and 330). However, if the content stream is not valid, then process 300 continues at act 336.

At act 336 of FIG. 4c, proxy server 108 requests information regarding the requested content stream from origin server 104 (act 336), and receives the requested information, including cache control information (e.g., including one or more directives of Table I discussed above), from origin server 104. The requested communication to origin server 104 in act 336 can be referred to as a 19 Get Content Information request, and may take a variety of different forms. In one implementation, the Get Content Information request is formatted as follows for HTTP:
GET /filename HTTP/1.1
Content-type: application/x-wms-getcontentinfo
   and as follows for RTSP:
GET_PARAMETER filename RTSP/1.0
Content-type: application/x-wms-getcontentinfo
   where filename is the name of the file including the requested content stream. The content-type:application/x-wms-getcontentinfo parameter is a MIME type that informs the recipient of the request (server 104) how to handle and respond to the request. The Get Content Information request can alternatively be formatted in different manners and may use different requests (e.g., using a RTSP DESCRIBE request).

It should be noted that, in acts 336 and 338, proxy server 108 can obtain cache control information for the content stream before streaming of the content from server 104 begins. This allows proxy server 108 to communicate the information to client 102, as well as prepare for splitting or caching of the content stream.

Additional handshaking as needed may also occur between the client 102 and origin server 104 via proxy server 108 (act 340). The exact nature of this additional handshaking can vary by implementation and the desires of origin server 104. For example, authentication (e.g., using one or more authentication packages as identified by the authentication directive of the cache control information) may be performed in act 340.

Proxy server 108 then determines whether to cache the content stream about to be received from the origin server (act 342). Virtually any number of different factors may be used by proxy server 108 in making this determination. Which factors are used are determined by the developer of proxy server 108. In one implementation, proxy server 108 may use one or more of the following factors: whether the origin server has indicated the content is not to be cached (e.g., based on the proxy cache directive in the cache control information)—proxy server 108 determines not to cache content that the origin server has indicated is not to be cached; whether there is sufficient space in the cache to store the content stream (e.g., based on the amount of available cache storage space and the content size directive in the cache control information)—if there is sufficient space in the cache (e.g., optionally after evicting one or more other pieces of content from the cache) then proxy server 108 determines to cache the content, otherwise the content is not cached; the popularity of the content—proxy server 108 caches content that is more popular (e.g., requested more often relative to other content); the time of day—proxy server 108 may cache more content during peak network usage times; size of the content (e.g., proxy server 108 may give preference to caching smaller pieces of content); bandwidth used by the client (e.g., proxy server 108 may give preference to caching higher bandwidth content); fees paid—proxy server 108 may cache content only for users paying a particular fee; and so forth.

Proxy server 108 then proceeds based on whether it is going to cache the content stream (act 344). If proxy server 108 is not going to cache the content stream, then proxy server 108 may proceed to stream the requested content stream being received from the origin server to the client (proxy server 108 typically does proceed to stream the requested content stream, although there is no obligation for server 108 to do so), and communicates any subscribed-to events (e.g., as indicated by the event-subscription directive in the cache control information for the content stream) to the origin server (act 316). However, if proxy server 108 is going to cache the content, then proxy server 108 stores the received cache control information and content stream in its cache (act 346) and proceeds to stream the requested content stream being received from the origin server to the client and communicate any subscribed-to events (e.g., as indicated by the event-subscription directive in the cache control information for the content stream) to the origin server (act 316). Proxy server 108 also typically (but not necessarily) stores information regarding the cached content in its cache, such as the cache control information, the expiration date, etc.

Situations can arise where proxy server 108 initially determines to cache the content and subsequently determines to not cache the content. For example, a play list can have cache control information associated with the entire play list, and also have different cache control information associated with each piece of content in the play list. This piece-specific cache control information is typically communicated from origin server 104 to proxy server 108 when origin server 104 begins streaming the piece to proxy server 108. Thus, although the play list may be on-demand, one or more pieces of content in the play list may be broadcast. So, if proxy server 108 initially determined to cache the content because the play list was on-demand, this determination may subsequently change when the cache control information for the broadcast piece of content is received (at which point proxy server 108 stops caching the content, and deletes from its cache the content already cached). By way of another example, client device 102 may request to change the bit rate of the content during streaming (e.g., due to a user-request, due to changes in available network bandwidth, etc.) or the types of data to be streamed (e.g., change from streaming audio and video streams to only the video stream). In order to avoid the situation where client device 102 has a cached copy of the content with changes to the streams, when a request for such a change is received from the client device, proxy server 108 stops caching the content (and deletes from its cache the content already cached). Alternatively, proxy server 108 may establish a new connection to the origin server and obtain the content stream at the new bit rate via the new connection (thus, the caching of the content stream at proxy server 108 at the original bit rate can continue unaffected by client-requested bit rate changes during streaming).

Additionally, situations can arise where proxy server 108 requests more streams from the origin server than are streamed to client device 102. For example, particular content may have multiple different bit streams (e.g., audio streams with different bit rates, video streams with different bit rates, etc.) of the content, such as for different playback qualities, commonly referred to as multi-bit rate content. If client device 102 requests a particular one of the multiple streams, then proxy server 108 may obtain and cache all of the streams for the content from the origin server, but only stream the requested stream to client device 102. Subsequent requests for a different stream of the content (or the same stream) from another client device 102 can thus be satisfied by proxy server 108 from its cache, as all the streams for the content are in its cache.

FIG. 5 illustrates an exemplary general computer environment 400, which can be used to implement the techniques described herein. The computer environment 400 is only one example of a computing environment and is not intended to suggest any limitation as to the scope of use or functionality of the computer and network architectures. Neither should the computer environment 400 be interpreted as having any dependency or requirement relating to any one or combination of components illustrated in the exemplary computer environment 400.

Computer environment 400 includes a general-purpose computing device in the form of a computer 402. Computer 402 can be, for example, a client 102 or server 104 or 108 of FIGS. 1 and 2. The components of computer 402 can include, but are not limited to, one or more processors or processing units 404, a system memory 406, and a system bus 408 that couples various system components including the processor 404 to the system memory 406.

The system bus 408 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 402 typically includes a variety of computer readable media. Such media can be any available media that is accessible by computer 402 and includes both volatile and non-volatile media, removable and non-removable media.

The system memory 406 includes computer readable media in the form of volatile memory, such as random access memory (RAM) 410, and/or non-volatile memory, such as read only memory (ROM) 412. A basic input/output system (BIOS) 414, containing the basic routines that help to transfer information between elements within computer 402, such as during start-up, is stored in ROM 412. RAM 410 typically contains data and/or program modules that are immediately accessible to and/or presently operated on by the processing unit 404.

Computer 402 may also include other removable/non-removable, volatile/non-volatile computer storage media. By way of example, FIG. 14 illustrates a hard disk drive 416 for reading from and writing to a non-removable, non-volatile magnetic media (not shown), a magnetic disk drive 418 for reading from and writing to a removable, non-volatile magnetic disk 420 (e.g., a “floppy disk”), and an optical disk drive 422 for reading from and/or writing to a removable, non-volatile optical disk 424 such as a CD-ROM, DVD-ROM, or other optical media. The hard disk drive 416, magnetic disk drive 418, and optical disk drive 422 are each connected to the system bus 408 by one or more data media interfaces 426. Alternatively, the hard disk drive 416, magnetic disk drive 418, and optical disk drive 422 can be connected to the system bus 408 by one or more interfaces (not shown).

The disk drives and their associated computer-readable media provide non-volatile storage of computer readable instructions, data structures, program modules, and other data for computer 402. Although the example illustrates a hard disk 416, a removable magnetic disk 420, and a removable optical disk 424, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 416, magnetic disk 420, optical disk 424, ROM 412, and/or RAM 410, including by way of example, an operating system 426, one or more application programs 428, other program modules 430, and program data 432. Each of such operating system 426, one or more application programs 428, other program modules 430, and program data 432 (or some combination thereof) may implement all or part of the resident components that support the distributed file system.

A user can enter commands and information into computer 402 via input devices such as a keyboard 434 and a pointing device 436 (e.g., a “mouse”). Other input devices 438 (not shown specifically) may include a microphone, joystick, game pad, satellite dish, serial port, scanner, and/or the like. These and other input devices are connected to the processing unit 404 via input/output interfaces 440 that are coupled to the system bus 408, but may be connected by other interface and bus structures, such as a parallel port, game port, or a universal serial bus (USB).

A monitor 442 or other type of display device can also be connected to the system bus 408 via an interface, such as a video adapter 444. In addition to the monitor 442, other output peripheral devices can include components such as speakers (not shown) and a printer 446 which can be connected to computer 402 via the input/output interfaces 440.

Computer 402 can operate in a networked environment using logical connections to one or more remote computers, such as a remote computing device 448. By way of example, the remote computing device 448 can be a personal computer, portable computer, a server, a router, a network computer, a peer device or other common network node, and the like. The remote computing device 448 is illustrated as a portable computer that can include many or all of the elements and features described herein relative to computer 402.

Logical connections between computer 402 and the remote computer 448 are depicted as a local area network (LAN) 450 and a general wide area network (WAN) 452. Such networking environments are commonplace in offices, enterprise-wide computer networks, intranets, and the Internet.

When implemented in a LAN networking environment, the computer 402 is connected to a local network 450 via a network interface or adapter 454. When implemented in a WAN networking environment, the computer 402 typically includes a modem 456 or other means for establishing communications over the wide network 452. The modem 456, which can be internal or external to computer 402, can be connected to the system bus 408 via the input/output interfaces 440 or other appropriate mechanisms. It is to be appreciated that the illustrated network connections are exemplary and that other means of establishing communication link(s) between the computers 402 and 448 can be employed.

In a networked environment, such as that illustrated with computing environment 400, program modules depicted relative to the computer 402, or portions thereof, may be stored in a remote memory storage device. By way of example, remote application programs 458 reside on a memory device of remote computer 448. For purposes of illustration, application programs and other executable program components such as the operating system are illustrated herein as discrete blocks, although it is recognized that such programs and components reside at various times in different storage components of the computing device 402, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method, implemented in a caching proxy server, the method comprising:
receiving, from a client, a request to retrieve streaming media content;
requesting, in response to the client request, information about the streaming media content from a server from which the streaming media content can be obtained; and
receiving, prior to receiving the requested streaming media content from the server, information from the server about the streaming media content including one or more cache control directives regarding the streaming media content.

2. A method as recited in claim 1, wherein the server comprises an origin server.

3. A method as recited in claim 1, wherein the streaming media content comprises a play list including multiple pieces of streaming media content, wherein the receiving comprises receiving information including one or more cache control directives for the play list, and further comprising receiving, for each of the multiple pieces of streaming media content, additional information including one or more additional cache control directives for regarding the piece of streaming media content.

4. A method as recited in claim 1, wherein the receiving comprises receiving the information in a message including the one or more cache control directives prior to receiving any messages including the streaming media content.

5. A method as recited in claim 1, wherein the one or more cache control directives include a proxy split directive to indicate that the streaming media content is a broadcast stream that can be split by the caching proxy server.

6. A method as recited in claim 1, wherein the one or more cache control directives include a proxy cache directive to indicate that the streaming media content can be cached by the caching proxy server only if the caching proxy server is a streaming media caching proxy server.

7. A method as recited in claim 1, wherein the one or more cache control directives include an authentication directive that indicates that authentication of the client by the server is required as well as one or more authentication packages that can be used for the authentication.

8. A method as recited in claim 1, wherein the one or more cache control directives include an event subscription directive that indicates which of one or more events regarding the streaming media content are to be communicated to the server.

9. A method as recited in claim 1, wherein the one or more cache control directives include a stream type directive that indicates a type of the streaming media content.

10. One or more computer readable media having stored thereon a plurality of instructions that, when executed by one or more processors of a server, causes the one or more processors to:
receive, from a streaming media caching proxy server, a request for information about streaming media content available from the server; and
communicate, prior to communicating information about the streaming media content to the streaming media caching proxy server, information about the streaming media content to the streaming media caching proxy server, wherein the information includes one or more cache control directives indicating how the streaming media caching proxy server is to handle the streaming media content.

11. One or more computer readable media as recited in claim 10, wherein the one or more cache control directives include a proxy split directive to indicate that the streaming media content is a broadcast stream that can be split by the caching proxy server.

12. One or more computer readable media as recited in claim 10, wherein the one or more cache control directives include a proxy cache directive to indicate that the streaming media content can be cached by a streaming media caching proxy server.

13. One or more computer readable media as recited in claim 10, wherein the one or more cache control directives include a content size directive that identifies a size of the streaming media content.

14. One or more computer readable media as recited in claim 10, wherein the one or more cache control directives include an event subscription directive that indicates which of one or more events regarding the streaming media content are to be communicated to the server.

15. One or more computer readable media as recited in claim 10, wherein the one or more cache control directives include a stream type directive that indicates a type of the streaming media content.

16. A method, implemented in a caching proxy server, the method comprising:
receiving different streaming media content from one or more servers;
for each piece of streaming media content received, checking a type of the streaming media content; and
managing caching of the streaming media content based on the type of the streaming media content, wherein different types of streaming media content are managed differently.

17. A method as recited in claim 16, wherein managing caching of the streaming media comprises checking whether broadcast streaming media content can be split and checking whether on-demand streaming media content can be cached.

18. A method as recited in claim 16, wherein the type of the streaming media content comprises on-demand content or broadcast content.

19. A method as recited in claim 16, wherein the type of the streaming media content comprises play list content or non-play list content.

20. A method as recited in claim 16, wherein the checking comprises accessing a cache-control header of a message associated with the streaming media content to determine the type of the streaming media content.
